(19) United States
(12) Patent Application Publication
(10) Pub. No.: US 2024/0171847 A1
(43) Pub. Date: May 23, 2024

(54) Stand for an image recording device, in particular a thermal imaging camera, and system for detecting objects comprising a stand of this kind

(71) Applicant: Xspecter GmbH, Dachsbach (DE)

(72) Inventor: Matthias MÄHLER, Uehlfeld (DE)

(21) Appl. No.: 18/551,106

(22) PCT Filed: Mar. 9, 2022
(86) PCT No.: PCT/EP2022/055974

§ 371 Date: Sep. 18, 2023

(30) Foreign Application Priority Data
Mar. 17, 2021 (DE) 20 2021 101 357.5

(51) Int. Cl. H04N 23/62; F16M 11/10; F16M 11/20; G01S 17/08; G02B 27/01; G02B 27/20; G03B 17/56; H04N 23/56; H04N 23/66

(52) U.S. Cl. CPC H04N 23/62; F16M 11/10; F16M 11/2014; G01S 17/08; G02B 27/017; G02B 27/20; G03B 17/561; H04N 23/56; H04N 23/66

(57) ABSTRACT

A stand for an image recording device including a fastening unit for detachably fastening the stand to a surface, a rotary plate which is rotatable about a rotation axis with respect to the fastening unit, a rotary drive for rotating the rotary plate about the rotation axis, a base which is fastened to the rotary plate so as to be pivotable about a pivot axis, a pivot drive for pivoting the base, a coupling unit which is fastened to the base for detachably fastening the image recording device, a power source which is connected to the rotary drive and to the pivot drive, an open-loop/closed-loop control unit which is connected in a signal-transmitting manner to the rotary drive and to the pivot drive for actuating the drives with open-loop and/or closed-loop control, a remote control means which is connected in a signal-transmitting manner to the open-loop/closed-loop control unit.

### CROSS-REFERENCES TO RELATED APPLICATIONS

This application claims the priority of German Utility Model Application, Serial No. DE 20 2021 101 357.5, filed Mar. 17, 2021, the content of which is incorporated herein by reference in its entirety as if fully set forth herein.

### FIELD OF THE INVENTION

The invention relates to a stand for an image recording device, in particular a thermal imaging camera, and to a system for recording objects with a stand of this kind.

### BACKGROUND OF THE INVENTION

The detection of objects with an image recording device, in particular the detection of living beings, in particular wild animals, with a thermal imaging camera, is known, for example, among hunters. When monitoring large-area districts, it has proven expedient to use the thermal imaging camera from a moving vehicle, in particular a passenger car. Since car windows are not transmissive for the spectral range of infrared radiation that is relevant for the thermal imaging camera, monitoring with the thermal imaging camera must be carried out through an open window in the car. Such monitoring is not very comfortable, in particular when the outside temperature is cold in the winter months.

Thermal imaging cameras exist that have an integrated fastening apparatus to attach them to an exterior of the motor vehicle. This integrated solution is costly. Due to the integrated fastening apparatus, the thermal imaging camera is not very flexible with regard to its further use. In particular, the use of the thermal imaging camera with integrated fastening apparatus as a hand-held device is disadvantageous due to the increased weight.

### SUMMARY OF THE INVENTION

It is an object of the invention to improve the monitoring of objects, in particular of living beings and in particular of wild animals, and in particular to provide a flexible and cost-efficient solution.

This object is achieved by a stand for an image recording device, in particular a thermal imaging camera, wherein the stand comprises a fastening unit for detachably fastening the stand to a surface, a rotary plate which is rotatable about a rotation axis with respect to the fastening unit, a rotary drive for rotating the rotary plate about the rotation axis, a base which is fastened to the rotary plate so as to be pivotable about a pivot axis, a pivot drive for pivoting the base, a coupling unit which is fastened to the base for detachably fastening the image recording device, a power source which is connected to the rotary drive and to the pivot drive, an open-loop/closed-loop control unit which is connected in a signal-transmitting manner to the rotary drive and to the pivot drive for actuating the drives with open-loop and/or closed-loop control, and a remote control means which is connected in a signal-transmitting manner to the open-loop/closed-loop control unit.

This object is further achieved by a system for detecting objects, wherein said system comprises a stand according to the invention which can be detachably fastened to a surface, an image recording device which can be coupled to the stand, in particular a thermal imaging camera, a display device which is connected in a signal-transmitting manner to the image recording device.

According to the invention, it has been recognized that an image recording device, in particular a thermal imaging camera, in particular an optical camera and/or in particular a camera with night vision function, can advantageously be used for the detection of objects, in particular living beings and in particular wild animals, with a stand which can be detachably fastened to a surface. In particular, a substantially flat component on an exterior of a motor vehicle, which is oriented substantially horizontally in a basic position, serves as a surface. For example, the motor vehicle roof, the front flap, the rear flap or a loading platform can serve as a surface. The stand has a fastening unit, which in particular defines a fastening plane.

The stand has, in particular, a coupling unit to detachably connect the image capturing device to the stand. The coupling unit is in particular fastened to a base of the stand. In particular, the coupling unit is designed as a so-called quick-change adapter which, with a corresponding counterpart which is fastened to the thermal imaging camera, enables uncomplicatedly manageable and yet secure coupling of the thermal imaging camera with the stand. The coupling unit can also be configured by a screw connection.

According to the invention, it has been recognized that the stand enables a flexible and cost-efficient use of a thermal imaging camera known per se.

In particular, it has been found that the use of mobile thermal imaging cameras is common among hunters. A user who is already in possession of a thermal imaging camera can use the stand according to the invention to create a system which enables him to monitor wild animals in a particularly convenient manner. The capital expenditure is reduced. Furthermore, the stand enables a reliable detection of living beings, in particular of wild animals. Due to the fact that the thermal imaging camera can be reliably fastened to a motor vehicle by means of the stand, even large-area districts can be comfortably covered by the motor vehicle, wherein the thermal imaging camera can remain in the position determined by the stand.

When the use of the thermal imaging camera with the stand is finished, the user can easily decouple the thermal imaging camera from the stand and use it—as before—for example as a mobile thermal imaging camera. In particular, it is not necessary for the user to purchase an additional, second and particularly costly integrated thermal imaging camera. The stand provides a flexible and cost-efficient solution, in particular for hunters.

The stand has a rotary plate which can be rotated about a rotation axis with respect to the fastening unit. The rotation axis is oriented in particular perpendicularly to the fastening plane. A rotary drive is provided for rotating the rotary plate about the rotation axis. The rotary drive enables the rotary plate to be rotated about the rotation axis. If the stand is arranged on a horizontal surface, the rotation axis is oriented vertically. The base, which can be pivoted about a pivot axis, is attached to the rotary plate. The pivot axis is oriented transversely and in particular perpendicularly to the rotation axis. In particular, the pivot axis is oriented horizontally. A pivot drive is provided for pivoting the base.

The stand further has at least one power source to supply the rotary drive and the pivot drive with electric current. The power source is designed in particular as a rechargeable battery, i.e. as an accumulator. Lithium-ion accumulators have proved to be particularly advantageous. Such accumulators have a high specific energy density, in particular more than 100 Wh/kg, in particular at least 125 Wh/kg and in particular at least 150 Wh/kg. The accumulator enables the stand to be operated for at least 2 hours, in particular at least 4 hours, in particular at least 5 hours and in particular at least 6 hours. It is particularly advantageous if the accumulator has a charging connection in the form of a USB socket. This enables in particular mobile charging of the power source, in particular via the motor vehicle itself and/or via a mobile power storage device, in particular a so-called power bank. The charging connection for the power source can also have another connection socket, in particular according to a standardized connection.

In particular, the stand has several charging connections, in particular at least one charging connection in a region of the stand that is spatially adjacent to the coupling unit. This simplifies an at least temporary power supply of the image recording device. The at least one charging connection is designed in particular as a so-called power port and is used in particular for charging the image recording device and/or the power source.

It is advantageous if the stand has a mechanical receptacle, in particular a holder, in particular for inserting and/or pushing in a mobile power storage device. The carrying of a power storage unit with the stand is thereby improved, in particular the reliable and loss-free carrying is ensured. This enables a reliable power supply. Several receptacles or holders for mobile power storage devices, so-called power banks, can be provided on the stand. For this purpose, the receptacles can be designed in a shaft-like or tab-like manner and, in particular, be designed with a closure element such as straps or flaps and/or enable a power bank to be received in a clamping manner. The inside of the receptacle can be lined with a soft elastic material for protection.

The stand has an open-loop/closed-loop control unit by means of which the rotary drive and the pivot drive can be actuated with open-loop control and in particular actuated with closed-loop control. This improves the functionality of the stand, in particular for the use of the thermal imaging camera that can be fastened to the stand. The open-loop/closed-loop control unit is connected in a signal-transmitting manner in particular to the rotary drive and to the pivot drive. This signal connection is in particular wired and thus particularly robust. However, it is also possible to implement this signal connection wirelessly.

A remote control means is used to operate the stand. The remote control means is connected in a signal-transmitting manner to the open-loop/closed-loop control unit. This signal connection is in particular configured to be wireless, in particular as radio signal transmission and in particular by means of Bluetooth technology. In principle, it is also conceivable to implement this signal connection in a wired manner. In particular, the remote control means has input elements in order to transmit a desired actuation of the drives and/or other components to the open-loop/closed-loop control unit. An operating element in the form of a joystick has proven to be advantageous for actuating the rotary drive and the pivot drive. The remote control means can have an integrated power source, which in particular has a charging connection in the form of a USB socket analogously to the power source of the stand. In particular, the power source is designed as an accumulator and is in particular identical to the accumulator of the stand.

A stand comprising a housing, wherein in particular the open-loop/closed-loop control unit, the rotary drive and/or the power source are arranged in the housing, is of robust design. A housing has in particular an interior space in which in particular the open-loop/closed-loop control unit, the rotary drive and/or the power source are arranged. The components arranged in the housing are protected, in particular splash-proof and correspond in particular to protection class IP44. The housing has, in particular, a detachably mounted lid which can be connected, in particular by screwing. Accessibility to the interior space of the housing is thus simplified. The housing itself is made in particular of a plastic material, which is in particular inexpensive and lightweight. It is also possible to manufacture the enclosure from metal, in particular sheet metal or die-cast metal parts, wood and/or glass.

A fastening unit, in which the fastening unit has several fastening elements, in particular suction cups, can be used flexibly. It is particularly advantageous if the fastening unit has several fastening elements, in particular in order to compensate for unevenness of the surface. Motor vehicle roofs in particular are typically configured to be at least slightly curved. By using several fastening elements, in particular two and in particular three or more, it is possible to attach the stand reliably and in a defined manner to curved surfaces. The use of suction cups is error-proof and cost-efficient. It is conceivable to provide instead of the suction cups or additionally the attachment by means of a magnetic element. In particular, it is conceivable that the fastening unit comprises both at least one suction cup and at least one magnetic foot.

It is particularly advantageous if the fastening elements of the fastening unit can be variably arranged on the base. In particular, the fastening elements are pivotably fastened to the base by means of a ball head fastening. As a result, the fastening elements can each be individually pivotably aligned with respect to the base. This enables flexible and reliable fastening to almost any curved surface.

In addition or alternatively, at least one fastening element can be designed to ensure a firm, in particular temporary, fastening to a surface. The at least one fastening element can enable screw fastenings. A screw fastening enables in particular a permanently reliable fastening. The monitoring of static objects, in particular buildings, is thereby improved.

A stand, in which the base is attached to the rotary plate so as to be pivotable about a rolling axis, enables better image stabilization. For this purpose, the base is attached to the rotary plate so as to be pivotable about a rolling axis. The rolling axis is oriented transversely and in particular perpendicularly to the pivot axis.

In particular, the base is arranged to pivot on the rotary plate in such a manner that the base is automatically moved back to a vertical basic position, in particular by gravity, if it has been unintentionally deflected from the basic position as a result of a driving movement of the motor vehicle. In this way, unevenness in the terrain can be advantageously compensated. Additionally or alternatively, it is conceivable to provide a rolling drive which causes a corresponding compensating rolling movement as soon as the base is deflected from the vertical basic position, in particular as a result of an inclination of the terrain. Such a rolling drive is in particular connected in a bidirectional signal-transmitting manner to the open-loop/closed-loop control unit. In particular, the stand may have at least one tilt sensor that detects a deflection of the stand relative to the vertical basic orientation. The sensor is connected in a signal-transmitting manner to the open-loop/closed-loop control unit.

A stand, in which the rotary drive and/or the pivot drive is designed as an electric motor, in particular as a brushless motor, enables precise control of the rotary drive and/or the pivot drive. The design as a brushless motor has proven to be particularly advantageous. The use of servo motors is also conceivable.

A stand, in which the remote control means is in wireless signal connection with the open-loop/closed-loop control unit, enables uncomplicated handling. The stand can be conveniently controlled by an operator in the motor vehicle, in particular with the window closed. In particular, the signal connection is made by means of a radio connection, in particular by means of Bluetooth. It is advantageous if the signal connection between the remote control means and the open-loop/closed-loop control unit has a range of at least 5 m, in particular at least 10 m and in particular at least 20 m.

A stand comprising a position sensor which is arranged in particular in the housing enables use in conjunction with a thermal imaging camera, in particular by position tracking. A position sensor is in particular connected to the GPS. The position sensor is in particular arranged in the housing.

A stand comprising a distance sensor which is arranged in particular in the housing enables in particular a so-called tracking mode of the thermal imaging camera, which can be used for tracking a detected living being. In particular in combination with the position sensor, it is thereby possible to track an object detected as a target by means of the stand, in particular with open-loop and in particular with closed-loop control. The distance sensor is in particular arranged in the housing. The distance sensor is designed in particular as a laser distance sensor and can detect distances over several 100 m.

In particular, an operating mode of the stand is conceivable in which the user identifies an object displayed by the camera as a target on the display unit, in particular by touching a specific region of the touch screen. For a target identified in this way, the position sensor can determine the distance and have it output as information via the display unit. This distance information is particularly important for a hunter, in particular before firing a shot.

Advantageously, the distance sensor is arranged at or integrated into the stand. Additionally or alternatively, the distance sensor can be arranged at or integrated into the camera.

The sensors according to the invention are in particular connected in a signal-transmitting manner to the open-loop/closed-loop control unit.

The distance sensor serves in particular to detect a distance to an object. The distance sensor can generate a distance signal and transmit it to the open-loop/closed-loop control unit, which can generate a corresponding control signal from the distance signal. Such a control signal is used in particular for an automatic focusing system. The automatic focusing system serves in particular for the automated, and in particular fully automated, focusing of a camera, and in particular of a thermal imaging camera. In particular, the automatic focusing system serves for focusing a lens attached to the camera. For this purpose, the automatic focusing system can have an actuating drive, in particular a servomotor, which interacts with a mechanism such that the lens can be operated in an automated manner.

Alternatively, it is possible for the automatic focusing system to be actuated independently of the control signal of the distance sensor by a user performing a corresponding focusing, i.e. setting the focus, on the lens on the basis of the image transmitted to the terminal device. For this purpose, an input device can be connected in a signal-transmitting manner to the open-loop/closed-loop control unit and enable the user to change the distance setting on the lens via the automatic focusing system. The input device can be a touch screen of the terminal device, which for example has logical “+” and “−” buttons. The buttons may also be mechanical buttons, in particular outside the touch screen, in particular as part of the remote control means. The user can focus intuitively. In particular, the user can perform focusing of the camera without having to touch the camera. Both the basic distance setting and a possible readjustment are possible in an automated manner.

A stand comprising at least one lighting element for illuminating the surroundings has an extended functionality. By means of a lighting element, in particular an LED lighting element, in particular an LED spotlight, it is possible to illuminate a target region, in particular a wildlife accident site. This makes it easier to work in the dark.

It is particularly advantageous if the lighting element can generate an adjustable light cone by means of an automatic adjustment system. The lighting element is in particular a focusable lighting element, in particular a focusable headlamp. In particular, the luminous range of the lighting element can be changed in a targeted manner by means of an adjustment drive, in particular by means of a controllable servomotor, in particular the motor enables the lens to be displaced such that the luminous range can be changed in a targeted manner. The targeted change of the luminous range can be carried out in particular via an input device that is connected in a signal-transmitting manner to the open-loop/closed-loop control unit.

A stand, in which a lens arrangement, in particular a controllable lens arrangement, is attached to the lighting element for variably setting the focal point of the at least one lighting element, enables flexible adaptation of the illumination with respect to the distance of the target region. In particular, it is conceivable that the motor vehicle with the stand attached thereto cannot approach a wildlife accident site or another target region unhindered. By means of a lens arrangement, it is possible to variably adjust the focal length of the lighting element. In particular, the lens arrangement is connected in a signal-transmitting manner to the open-loop/closed-loop control unit. The lens arrangement can be arranged in addition to the lighting element or integrated in the lighting element.

A stand comprising a marking element, in particular an optical one, for optically marking a target object enables marking, in particular optically, of the target object. For example, an infrared light signal and/or a laser light signal, in particular a laser spot, serves as a marking element. It is thus possible to illuminate a target object, in particular a wild animal, with the marking element and thereby to mark it optically. A hunter using a firearm with infrared optics can find the target object marked in this way more easily.

A stand, in which the open-loop/closed-loop control unit is designed in such a manner that the rotary drive and/or the pivot drive can be operated in a search mode, in particular a search mode that can be automated, has improved functionality. In particular, the open-loop/closed-loop control unit enables a search mode. In the search mode, a variably determinable search range is defined in which the drives, in particular the rotary drive and/or the pivot drive, travel, i.e. scan, in particular according to a predetermined movement pattern. The search range is defined in particular by a pivot angle range for the rotary drive and/or the pivot drive. The respective angle range for the rotary drive and/or the pivot drive can be variably specified by the user. It is also conceivable to permanently store the angle range for the search mode in the open-loop/closed-loop control unit in order to simplify the handling of this function.

A system according to the invention has substantially the advantages of the stand according to the invention, to which reference is hereby made. Advantageously, the image signal generated by the image recording device is output via a display device. The display device is, for example, a tablet computer or a smartphone. However, the display device can also be a display permanently installed in the motor vehicle, which is already present in particular for multimedia applications in the motor vehicle, in particular for a navigation system. The signal connection between the image recording device and the display device is in particular wireless. In particular, the connection can be made via an application software, a so-called app, of the image recording device, which has a wireless internet interface. A wired signal connection is advantageous if the display device is permanently and in particular firmly installed in the motor vehicle.

The image recording device has optical and in particular thermal camera functions. The image recording device is in particular a thermal imaging camera. In particular, the image recording device has an optical zoom. It is also conceivable to use an optical camera as the image recording device.

A system, in which the display device is designed as VR glasses, which in particular are connected in a signal-transmitting manner to the open-loop/closed-loop control unit for controlling the stand, enables improved functionality. VR glasses can serve as a display device in addition or as an alternative to the aforementioned display devices. It is particularly advantageous if the VR glasses are connected in a bidirectional signal-transmitting manner to the open-loop/closed-loop control unit. In this case, it is possible to control the drives of the stand via a movement of the VR glasses, i.e. via a head movement of the wearer of the glasses.

Additionally or alternatively, it is possible that the drives of the stand are actuated by means of an input device, in particular a joystick, which a user can operate, in particular when wearing the VR glasses.

In particular, it has been found that the stand according to the invention and a system equipped therewith are suitable for use, for example, by security services and/or authorities, in particular security authorities. It is also possible to use the stand and/or the system for seafaring.

Both the features indicated above and the features indicated in the embodiment example of a stand according to the invention are each suitable, on their own or in combination with each other, for further embodying the subject-matter according to the invention. The respective combinations of features do not constitute a restriction with regard to the further embodiments of the subject-matter of the invention, but are essentially merely exemplary in character.

Further features, advantages and details of the invention will be apparent from the following description of embodiment examples based on the drawing.

### BRIEF DESCRIPTION OF THE DRAWING

FIG. 1 shows a perspective view of a schematized stand according to the invention,

FIG. 2 shows a perspective view onto an opened housing of the stand according to FIG. 1,

FIG. 3 shows a sectional view according to section line III-III in FIG. 1,

FIG. 4 shows a sectional view according to section lines IV-IV in FIG. 1.

### DESCRIPTION OF THE PREFERRED EMBODIMENTS

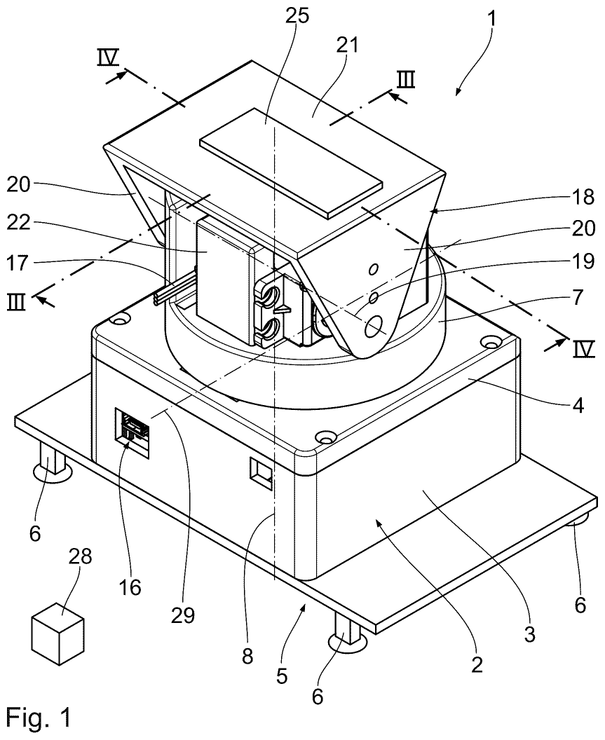

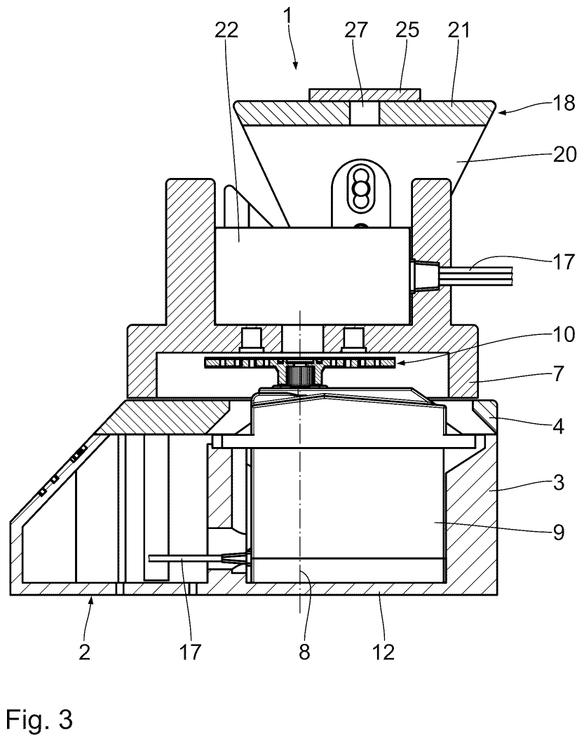

A stand marked 1 in FIGS. 1 to 4 as a whole has a housing 2 made of plastic material. The housing 2 comprises a housing base body 3 to which a lid 4 can be screwed. The housing base body 3 is essentially rectangular in shape.

A fastening unit 5 with fastening elements 6, shown purely schematically in FIG. 1, is provided on an underside of the housing 2 opposite the lid 4. The fastening elements 6 define a fastening plane of the fastening unit 5. The fastening plane is oriented in particular parallel to the fastening plate and in particular to the underside of the housing 2. The fastening unit 5 has a fastening plate, on the underside of which, facing away from the housing 2, at least one fastening element 6 is arranged. It is also conceivable to dispense with the fastening plate and to attach the fastening elements 6 directly to the underside of the housing 2. According to the embodiment example shown, four fastening elements 6 are arranged, in each case in the corner regions of the fastening plate. More or fewer fastening elements 6 can also be provided and/or arranged on the fastening plate or the housing 2. According to the embodiment example shown, the fastening elements 6 are each designed as suction cup fastenings.

A rotary plate 7 is arranged on the housing 2, in particular on the lid 4, so as to be rotatable about a vertical rotation axis 8. The rotation axis 8 is oriented in particular perpendicularly to the fastening plane.

The rotary plate 7 is mechanically coupled by means of a rotary drive 9. By means of the rotary drive 9, the rotary plate 7 can be rotated through an angle of rotation with respect to the rotation axis 8 relative to the housing 2. The angle of rotation can be set as desired. The rotary drive 9 allows a rotation angle range between 0° and 360°. The rotary drive 9 is designed as a brushless motor. The rotary drive 9 has a force transmission element 10 at its output. The force transmission element 10 is star-shaped and has several connection openings 11. The connection openings 11 are arranged eccentrically to the rotation axis 8. The force transmission element 10 is connected, in particular screwed, to the rotary plate 7 at at least one connection opening 11. The rotary movement of the rotary drive 9 is transmitted to the rotary plate 7 by the force transmission element 10 fastened to the output of the rotary drive 9.

The force transmission from the rotary drive 9 to the rotary plate 7 can also be effected in a different manner, for example by means of a gear connection or by positive engagement of the force transmission element 10 at a corresponding recess 12 in the rotary plate 7.

The rotary drive 9 is arranged in the housing 2. A motor holder can be provided in the housing 2 for this purpose. The motor holder is formed in particular by a corresponding recess 13 in the lid 4 of the housing. The arrangement of the rotary drive 9 in the housing 2 is thus additionally stabilized. The rotary drive 9 is reliably arranged on the bottom plate 12 of the housing 2.

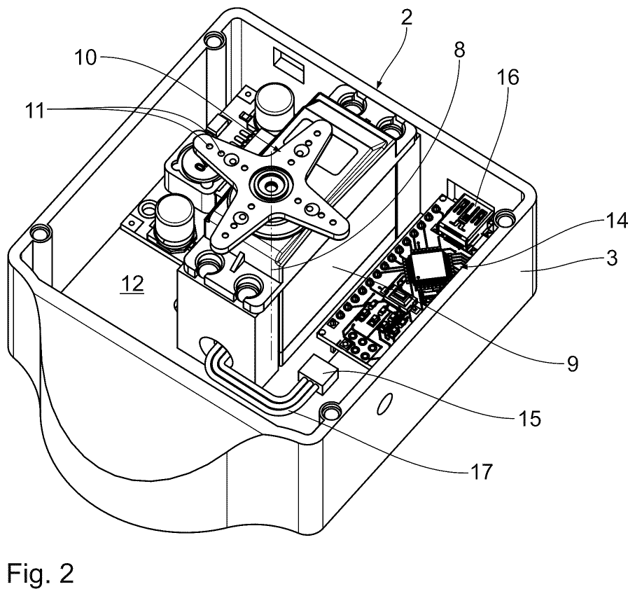

An open-loop/closed-loop control unit 14 is integrated in the housing 2. The open-loop/closed-loop control unit 14 is formed by several circuit boards which serve to actuate the rotary drive 9. The cable connections required for this are not shown for illustration reasons. The open-loop/closed-loop control unit 14 is connected to a purely schematically shown power source 15 in the form of an accumulator. The power source 15 can be charged via the charging connection 16, which is designed as a USB socket. The power source 15 is connected to the rotary drive 9 via a power cable 17. The power cable 17 is shown purely schematically in FIG. 2. For reasons of space, the power source 15 with the power cable 17 can also be arranged outside the housing 2.

A base 18 is attached to the rotary plate 7 so that it can pivot about a pivot axis 19. The base 18 is portal-shaped with two side plates 20 and a cover plate 21 connecting the side plates 20. In particular, the base 18 is made in one piece. The side plates 20 have a triangular contour in a plane perpendicular to the pivot axis 19. The cover plate 21 is rectangular in shape. The side plates 20 are each oriented perpendicularly to the pivot axis 19.

According to FIG. 1, the base 18 is in an initial position in which the cover plate 21 is oriented perpendicularly to the rotation axis 8 and in particular horizontally.

The stand 1 has a pivot drive 22 which enables a driven pivoting of the base 18 with respect to the pivot axis 19. The pivot drive 22 is arranged on the rotary plate 7 and in particular fastened thereto. A force transmission element 23, in particular in the form of a pivot lever, is attached to the out-put of the pivot drive 22. The pivot lever is connected to the output of the pivot drive 22 in a form-fit and/or force-fit manner. The pivot lever 23 has through openings 24 which can be fitted in alignment with corresponding openings in the base 18, in particular in one of the side plates 20. Via the aligned openings, a direct connection of the pivot lever 23 with the base 18, in particular the side plate 20, is possible. A pivoting movement of the pivot drive 22 is transmitted to the base 18 via the pivot lever 23. According to the embodiment example shown, a permissible pivot angle range for the pivot drive 22 with respect to the pivot axis 19 is −90° to +90°.

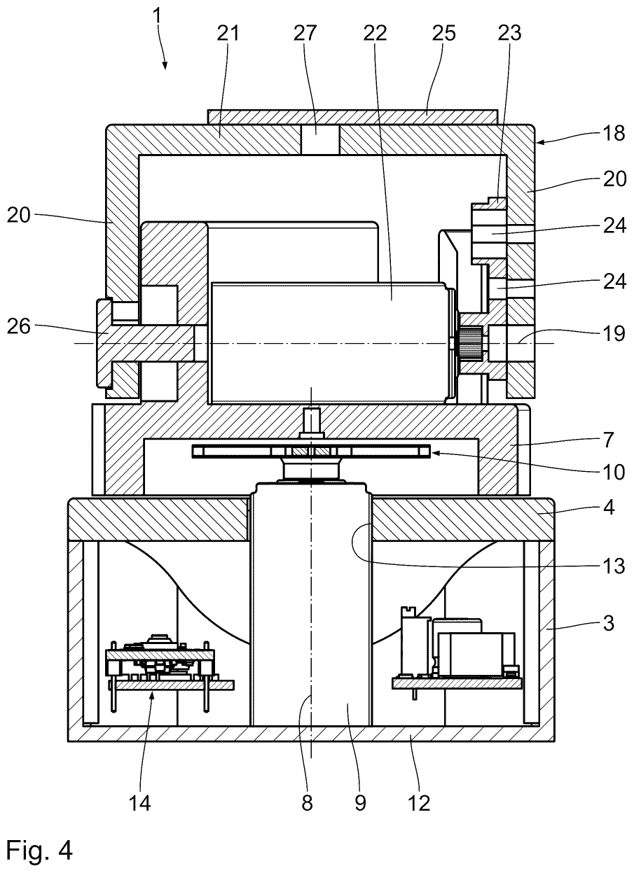

To stabilize the pivoting movement of the base 18, a guide pin 26 is arranged on the side plate 20 shown on the left in FIG. 4, which is arranged opposite the side plate 20 on which the pivot lever 23 engages. The guide pin 26 serves to guide the pivoting movement with respect to the pivot axis 19.

The pivot drive 22 is connected to the power source 15 via another power cable 17. The power cable 17 can also be routed inside the stand, in particular through the rotary plate 7 and the lid 4 into the housing 2.

A coupling unit 25, shown purely schematically in FIG. 1, is arranged on an upper side of the base 18, in particular the cover plate 21. The coupling unit 25 is designed, in particular, as a quick-change adapter which enables an uncomplicated and flexible coupling of an image recording device, in particular a thermal imaging camera, to the stand 1.

For fastening the coupling unit 25, a through-bore 27 is arranged in the base 18, in particular the cover plate 21, which can be used for screw fastening, for example.

The open-loop/closed-loop control unit 14 is connected in a signal-transmitting manner to the pivot drive 22.

For operating the stand 1 and in particular for controlling the drives 8, 22, a remote control means 28, shown purely schematically in FIG. 1, is used, which is connected in a signal-transmitting manner to the open-loop/closed-loop control unit 14 by means of a radio connection, in particular via Bluetooth.

The stand 1 has a rolling axis 29 which is oriented in particular perpendicularly to the rotation axis 8 and in particular perpendicularly to the pivot axis 19. In particular, the three axes 8, 19, 29 are each oriented perpendicularly to each other in pairs. The three axes 8, 19, 29 are oriented in the three spatial directions of a Cartesian coordinate system. It is advantageous if the stand 1, in particular the rotary plate 7 and/or the base 18, are mounted in a floating manner with respect to the rolling axis 29. In order to compensate for travel movements and, in particular, inclinations of the stand with respect to a vertical orientation, a rolling drive can be provided in particular, which enables an actuation movement of the deflected components about the rolling axis 29 back into a basic orientation. The rolling axis 29 can also be arranged at another position of the stand 1 with respect to the longitudinal axis 8 and/or with respect to the pivot axis 19.

1-14. (canceled)

15. A stand for an image recording device wherein the stand comprises
a) a fastening unit for detachably fastening the stand to a surface,
b) a rotary plate which is rotatable about a rotation axis with respect to the fastening unit,
c) a rotary drive for rotating the rotary plate about the rotation axis,
d) a base which is fastened to the rotary plate so as to be pivotable about a pivot axis,
e) a pivot drive for pivoting the base,
f) a coupling unit which is fastened to the base for detachably fastening the image recording device,
g) a power source which is connected to the rotary drive and to the pivot drive,
h) an open-loop/closed-loop control unit which is connected in a signal-transmitting manner to the rotary drive and to the pivot drive for actuating the drives with open-loop and/or closed-loop control,
i) a remote control means which is connected in a signal-transmitting manner to the open-loop/closed-loop control unit.

16. A stand according to claim 15, comprising a housing, wherein at least one of the open-loop/closed-loop control unit, the rotary drive and the power source are arranged in the housing.

17. A stand according to claim 15, wherein the fastening unit has several fastening elements.

18. A stand according to claim 15, wherein the base is attached to the rotary plate so as to be pivotable about a rolling axis.

19. A stand according to claim 15, wherein at least one of the rotary drive and the pivot drive is designed as an electric motor.

20. A stand according to claim 15, wherein the remote control means is in wireless signal connection with the open-loop/closed-loop control unit.

21. A stand according to claim 15, comprising a position sensor.

22. A stand according to claim 21, wherein the position sensor is arranged in the housing.

23. A stand according to claim 15, comprising a distance sensor.

24. A stand according to claim 23, wherein the distance sensor is arranged in the housing.

25. A stand according to claim 15, comprising at least one lighting element for illuminating the surroundings.

26. A stand according to claim 25, wherein a lens arrangement is attached to the lighting element for variably setting the focal point of the at least one lighting element.

27. A stand according to claim 26, wherein the lens arrangement is a controllable lens arrangement.

28. A stand according to claim 15, comprising a marking element for optically marking a target object.

29. A stand according to claim 15, wherein the open-loop/closed-loop control unit is designed in such a manner that at least one of the rotary drive and the pivot drive can be operated in a search mode.

30. A stand according to claim 29, wherein the search mode can be automated.

31. A system for detecting objects, wherein said system comprises
a) a stand for an image recording device, wherein the stand comprises
aa) a fastening unit for detachably fastening the stand to a surface,
bb) a rotary plate which is rotatable about a rotation axis with respect to the fastening unit,
cc) a rotary drive for rotating the rotary plate about the rotation axis,
dd) a base which is fastened to the rotary plate so as to be pivotable about a pivot axis,
ee) a pivot drive for pivoting the base,
ff) a coupling unit which is fastened to the base for detachably fastening the image recording device,
gg) a power source which is connected to the rotary drive and to the pivot drive,
hh) an open-loop/closed-loop control unit which is connected in a signal-transmitting manner to the rotary drive and to the pivot drive for actuating the drives with open-loop and/or closed-loop control,
ii) a remote control means which is connected in a signal-transmitting manner to the open-loop/closed-loop control unit, which can be detachably fastened to a surface,
b) an image recording device which can be coupled to the stand, and
c) a display device which is connected in a signal-transmitting manner to the image recording device.

32. A system according to claim 31, wherein the display device is de-signed as VR glasses, which are connected in a signal-transmitting manner to the open-loop/closed-loop control unit for controlling the stand.
